(19) United States
(12) Patent Application Publication
(10) Pub. No.: US 2017/0282227 A1
(43) Pub. Date: Oct. 5, 2017

(54) Surface coating for high-quality white and / or grayware

(71) Applicant: BSH Hausgeräte GmbH, Munich (DE)

(72) Inventors: Florian Eder, Erlangen (DE); Frank Jördens, Traunstein (DE); Marek Maleika, Fürth (DE); Felix Ntourmas, Erlangen (DE)

(21) Appl. No.: 15/473,665

(22) Filed: Mar. 30, 2017

(30) Foreign Application Priority Data
Mar. 31, 2016 (DE) 102016205318.3

(51) Int. Cl. B08B 17/00

(52) U.S. Cl. CPC B08B 17/00

(57) ABSTRACT

A surface coating for high-grade white and/or gray goods, i.e. items for domestic, sanitary and/or automotive use, in particular housing elements of corresponding devices and machines, as well as decoration, for example those housing elements which specifically have metallic applications and/or elements is disclosed. The surface coating is applied on a metallic or metalized surface structure and has hydrophobic property and/or oleophobic property. The surface coating is defined by a thickness which is less than a structure depth of the surface structure. The height of the surface roughness of the surface structure can thus extend significantly beyond the thickness of the surface coating, so that the surface structure promotes blurring of undesired residues in a kind of intrinsic capillary/channeling effect. Because of the blurring the contour of a soiling is obscured until finally it becomes wholly indistinguishable.

### CROSS-REFERENCES TO RELATED APPLICATIONS

This application claims the priority of German Patent Application, Serial No. 10 2016 205 318.3, filed Mar. 31, 2017, pursuant to 35 U.S.C. 119(a)-(d), the disclosure of which is incorporated herein by reference in its entirety as if fully set forth herein

### BACKGROUND OF THE INVENTION

The invention relates to a novel surface coating for high-grade white and/or gray goods, in other words items for domestic, sanitary and/or automotive use, in particular housing elements of corresponding devices and machines, as well as decoration, for example those housing elements which specifically have metallic applications and/or elements.

On the model of the watchmaking and jewelry sector, many predominantly higher-class products are now also specifically fitted with metallic elements, preferably made of stainless steel or aluminum, in many sectors of the domestic, sanitary or automotive industry. The basically shiny metallic and frequently also polished, brushed and/or otherwise structured surface is seen as modern and creates the perception of higher quality in the human mind. However, the disadvantage of these surfaces is that when in contact with their environment they are very susceptible to the adhesion of residues, for example moisture, residues of dust, sweat, grease and/or food, which inevitably occur in practice during operation and/or use in the usual areas of application such as kitchens, sanitary facilities, vehicles and/or aircraft interiors.

Such residues are immediately identified negatively in the human mind as soiling and thus at the same time significantly downgrade the impression of hygiene and the visual appearance of the surface. Another critical factor is that the frequently introduced surface microstructure makes cleaning the soiling more difficult and depending on the type of soiling, e.g. organic acids, said surface microstructure can also be attacked, which in the long term can result in a changed surface composition which has a negative impact on the external appearance.

To prevent these adhesive residues and/or to prevent damage to the structuring of the high-grade surfaces, recourse has long been had to coating, in some cases foil coating, in some cases by wet chemical procedures or coatings that can be manufactured using gas phase separation processes (PVD, CVD).

These foil and/or layer systems applied to the surfaces in question have been researched in accordance with the prior art such that thanks to a specific chemical composition they exhibit both the necessary repellent properties, i.e. hydrophobicity and oleophobicity, and/or ease of cleaning.

A disadvantage of these existing technical solutions is that as a result of the modification the application of the foil or layer generally has a negative impact on the external appearance and the haptic qualities of the surface. Thus in the human mind the metallic surface loses its originally quality-imparting character, especially in the case of foil and thick-film systems, both visually, i.e. in respect of the metal color, the metallic sheen, and haptically, for example when touching the structure.

### BRIEF SUMMARY OF THE INVENTION

It would therefore be desirable and advantageous to provide an improved surface finish for high-grade—namely metallic, metalized and/or structured—surfaces of vehicles and/or aircraft interiors, as well as white and gray goods to obviate prior art shortcomings and to render residues caused by use as indiscernible as possible and/or to facilitate cleaning

According to one aspect of the present invention, a surface coating on a metallic or metalized surface structure includes at least one property selected from the group consisting of hydrophobic property and oleophobic property, the surface coating defined by a thickness which is less than a structure depth of the surface structure.

To ensure clarity, it is necessary to establish the definition of several important terms and expressions that will be used throughout this disclosure.

The term “surface structure” relates to a commonly used structuring of metallic or metalized surfaces which is standard for high-grade surfaces, such as brushing, abrading, embossing, etching, etc.

The term “structure depth” relates to the roughness of the surface structure, measured in Ra (roughness, average), in other words the length from a structure valley to a structure peak on the structured surface without surface coating.

The terms “hydrophobic” and “oleophobic” relate to surface properties which in one case are water-repellent, i.e. hydrophobic, and in the other case are grease- or oil-repellent, i.e. oleophobic.

The term “thickness” of the surface coating relates to the extent of the coating transverse to the coated surface.

The present invention is based on the utilization of a previously unknown synergy effect which arises from the structure specifically introduced in practice, in particular a microstructure of the surface in question—for example brushed and/or abraded stainless steel and/or aluminum—and a thin functional coat applied thereto, which has either a hydrophobic and/or an oleophobic effect.

Thus tests with a surface coating in accordance with the invention on surfaces of series components with an abraded stainless steel structure have shown that in interaction with grease-emitting contact partners, e.g. Vaseline stamps and/or fingers, a surface effect occurs over time—on a scale of minutes—which results in a blurring of the locally deposited residues. The blurring of the residues preferably takes place in the direction of the existing surface structure, for example a longitudinal abrasion, and is accordingly the result of a kind of intrinsic capillary and/or channeling effect of the abrasion structure. It is advantageous here that the blurring is accompanied by a large reduction in the local intensity of soiling.

The quantity of residue spreads over a larger surface over time, so that as a result of the reduction in the manifestation of soiling in the direction of thickness the contrast between the soiled area compared to the unsoiled area becomes less and less, i.e. a diminution of contrast compared to the background is achieved. Thanks to the blurring effect the residues become less and less discernible to the human eye.

This surprising effect is now combined with the previously known layer systems, whereby in particular a surface coating that is as thin as possible, i.e. a layer in the nanometer range, is advantageous for the maintenance of this effect.

This is in particular also advantageous because a layer only a few nanometers thick—i.e. for example less than 100 nm—already exhibits the blurring effect here, but the surface of the goods otherwise naturally changes far less in respect of the metal sheen and/or the haptic qualities than a thicker surface coating, for example a surface coating in the micrometer range.

According to another advantageous feature of the present invention, the surface coating can have an anti-fingerprint property. The anti-fingerprint property may, for example be applied by plasma coating, in particular by atmospheric-pressure plasma. Other coating methods, for example coil coating, can likewise alternatively or additionally be used to produce a surface coating in accordance with the invention.

Anti-fingerprint in the case of surface coatings relate to properties, for example thin inorganic/organic hybrid coatings, that inhibit marks, i.e. the visibility of fingerprints, on metallic or metalized surfaces. They form a certain barrier against the lipid organic acids present in fingerprints and also against the inorganic salts from the fingerprint. They reduce the adhesion on the one hand and suppress the visibility of the residual adhesion on the other hand. This makes it significantly easier to remove the residual soiling.

According to another advantageous feature of the present invention, the layer thickness of the surface coating can lie in a range below 400 nm, preferably below 200 nm, further preferably below 100 nm. Currently preferred is a layer thickness of less than 60 nm.

According to another advantageous feature of the present invention, the surface coating can have a refractive index in a range between 1.4 and 1.5. This results in a further reduction in the visibility of the residues that also blur. Currently preferred is an adjustment of the refractive index of the surface coating in the range between 1.42 and 1.46. This has proven effective for the invisibility of the most frequent residues.

According to another advantageous feature of the present invention, the surface coating can be selected such that it has a low surface energy of between 10 and 30 mN/m. Currently preferred is a surface energy between 15 and 20 mN/m.

According to another aspect of the present invention, a substrate includes a surface structure defined by a roughness which lies in a range of Ra=1-100 μm, and a surface coating applied upon the surface structure and having at least one property selected from the group consisting of hydrophobic property and oleophobic property, said surface coating defined by a thickness which is less than a structure depth of the surface structure.

According to another advantageous feature of the present invention, the substrate can be metallic or metalized.

According to another advantageous feature of the present invention, the roughness of the surface structure can lie in the range of Ra=5 to 20 μm.

To adjust the refractive index, i.e. the visual density of the surface coating, the standard methods known from the practice of plasma coating, in particular atmospheric plasma coating, can be applied. For example, hybrid-organic precursors that contain carbon can be used here, to achieve the correct refractive index.

A precursor that can be mentioned as a substitute for the—for example—hydrophobic coating is HADS hexa-alkyl disiloxane, which for example in the form of its methyl derivative forms a thin film containing a large number of hydrophobizing alkyl groups on the surface after the plasma coating. Hydrohobization by a surface coating in principle causes the common above-mentioned residues to be repelled.

By partially removing the alkyl groups present in the precursor molecules and by a more or less complete cross-linking reaction of the excited precursor molecules the surface energy of the coating is adjusted, such that a more polar surface is created, from which greasy or oily residues are repelled.

Thanks to the present invention for the first time a connection is produced between a surface structuring and the surface coating of a high-grade metallic or metalized surface, such that the height of the surface roughness of the surface structuring extends significantly beyond the thickness of the surface coating, so that the surface structuring encourages a blurring of undesired residues in a kind of intrinsic capillary/channeling effect. Because of the blurring the contour of the soiling is obscured until finally it becomes wholly indistinguishable.

### BRIEF DESCRIPTION OF THE DRAWING

NONE

### DETAILED DESCRIPTION OF PREFERRED EMBODIMENTS

NONE

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A surface coating on a metallic or metalized surface structure, said surface coating comprising at least one property selected from the group consisting of hydrophobic property and oleophobic property, said surface coating defined by a thickness which is less than a structure depth of the surface structure.

2. The surface coating of claim 1, wherein the thickness of the surface coating is smaller approximately by a factor of 10 than a roughness of the surface structure.

3. The surface coating of claim 1, comprising an anti-fingerprint property.

4. The surface coating of claim 1, wherein the thickness of the surface coating is less than 400 nm.

5. The surface coating of claim 1, comprising a refractive index which lies in a range between 1.4 and 1.5.

6. The surface coating of claim 1, comprising a surface energy which lies in a range between 10 and 30 mN/m.

7. A substrate, comprising:
a surface structure defined by a roughness which lies in a range of Ra=1-100 μm; and
a surface coating applied upon the surface structure and having at least one property selected from the group consisting of hydrophobic property and oleophobic property, said surface coating defined by a thickness which is less than a structure depth of the surface structure.

8. The substrate of claim 7, wherein the substrate is metallic or metalized.

9. The substrate of claim 7, wherein the roughness lies in a range of Ra=5-20 μm.

10. The substrate of claim 7, wherein the thickness of the surface coating is smaller approximately by a factor of 10 than the roughness of the surface structure.

11. The substrate of claim 7, wherein the surface coating has an anti-fingerprint property.

12. The substrate of claim 7, wherein the thickness of the surface coating is less than 400 nm.

13. The substrate of claim 7, wherein the surface coating has a refractive index which lies in a range between 1.4 and 1.5.

14. The substrate of claim 7, wherein the surface coating has a surface energy which lies in a range between 10 and 30 mN/m.
